(19) United States
(12) Patent Application Publication
(10) Pub. No.: US 2009/0213075 A1
(43) Pub. Date: Aug. 27, 2009

(54) COMPUTER SYSTEM, DISPLAY CONTROL METHOD AND DISPLAY CONTROLLER

(75) Inventors: LUNG DAI, Tu-Cheng (TW); WANG-CHANG DUAN, Shenzhen City (CN); BANG-SHENG ZUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 12/195,429

(22) Filed: Aug. 21, 2008

(30) Foreign Application Priority Data
Feb. 22, 2008 (CN) 200810300380.5

(51) Int. Cl. G06F 3/033

(52) U.S. Cl. 345/163

(57) ABSTRACT

A display control method includes: generating an input signal according to a mouse input operation; detecting whether the input signal includes a scroll signal generated when a scroll wheel of the mouse is scrolled, and a press signal generated when a predetermined button of the mouse is pressed; and moving the contents of the document being displayed left or right when a detected result is the input signal including the scroll signal and the press signal.

### BACKGROUND

1. Field of the Invention

The present invention generally relates to computer systems, and particularly to a display control method and a display controller for a computer system.

2. Description of Related Art

When a word processing document, spreadsheet, Web page, or other such like document, is displayed in a display window of a computer screen, portions of the document may extend beyond the boundaries of the display window. As such, the document must be scrolled in order to read/view the entire document. In such a case, a horizontal scrollbar and a vertical scrollbar, with scroll sliders, will appear in the display window. These scrollbars with scroll sliders allow users to scroll the contents of the document to view other parts of the document. For example, either dragging the horizontal scroll slider or clicking on the horizontal scroll button by pressing a left button of a mouse may move the contents of the document left or right so as to read/view the other parts content of the document beyond the boundaries of the display. Likewise, dragging the vertical scroll slider or clicking on the vertical scroll button by pressing a left button of the mouse may move the document up or down.

Also a computer mouse having a scroll wheel may allow users to move the contents of the document up or down more conveniently than using the left mouse button of the mouse. However, when users desire to move the contents of the document left or right, users must press a shift button of a keyboard and rotate the scroll wheel at the same time. That is to say, both hands are needed in an operation to move the contents of the document left or right, which is also inconvenient for users.

Therefore, a display control method for conveniently scrolling the contents of a document displayed in a display window is desired, and a computer system and a display controller for conveniently scrolling the contents of the document displayed in a display window are also desired.

### SUMMARY

Accordingly, a display control method is provided. The display control method includes: generating an input signal according to a mouse input operation; detecting whether the input signal includes a scroll signal generated when a scroll wheel of the mouse is scrolled, and a press signal generated when a predetermined button of the mouse is pressed; and moving contents of the contents of the document being displayed left or right when a detected result is the input signal including the scroll signal and the press signal.

Other advantages and novel features will become more apparent from the following detailed description of exemplary embodiment when taken in conjunction with the accompanying drawings.

### BRIEF DESCRIPTION OF THE DRAWINGS

FIG. 1 is a flowchart showing a display control method in accordance with an exemplary embodiment.

FIG. 2 is a block diagram of a computer system in accordance with a first exemplary embodiment.

FIG. 3 is a block diagram of a computer system in accordance with a second exemplary embodiment.

### DETAILED DESCRIPTION

References will now be made to the drawings to describe exemplary embodiments of the present computer system and display control method and apparatus thereof.

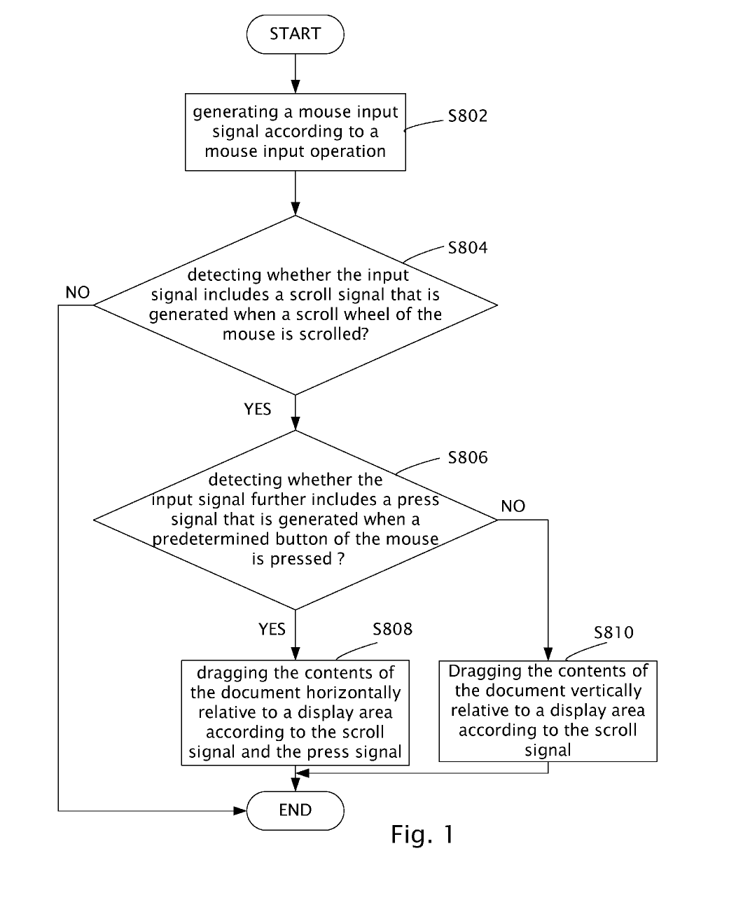

Referring to FIG. 1, a display control method for moving the contents of a document displayed in a display window of a computer system is illustrated in accordance with an exemplary embodiment.

In step S802, generating a mouse input signal according to a mouse input operation.

In step S804, detecting whether the input signal includes a scroll signal that is generated when a scroll wheel of the mouse is scrolled. When the input signal includes the scroll signal, the procedure goes to step S806. When the input signal does not include the scroll signal, the procedure ends.

In step S806, detecting whether the input signal further includes a press signal that is generated when a predetermined button of the mouse is pressed. When the input signal includes the press signal, the procedure goes to step S808. When the input signal does not include the press signal, the procedure goes to step S810.

In step S808, dragging the contents of the document horizontally relative to a display area according to the scroll signal and the press signal. More specifically, the contents of the document are dragged left relative to the display area so as to display a right portion contents of the document when the scroll signal is generated by rotating the scroll wheel in a predetermined first direction and the press signal is generated by pressing the predetermined button. The contents of the document are dragged right relative to the display area so as to show a left portion contents of the document when the scroll signal is generated by rotating the scroll wheel in a predetermined second direction opposite to the predetermined first direction and the press signal is generated by pressing the predetermined button.

In step S810, dragging the contents of document vertically relative to a display area according to the scroll signal. More specifically, the contents of the document is dragged in the up direction relative to the display area so as to show a bottom portion of the contents of the document when the scroll signal is generated by rotating the scroll wheel in the predetermined first direction. The contents of the document are dragged downwards relative to the display so as to show an upper portion of the contents of the document when the scroll signal is generated by rotating the scroll wheel in the predetermined second direction.

The predetermined button of the mouse may be a left button, a right button, or a third button of the mouse. The third button is configured for generating the press signal exclusively. Rotating the scroll wheel in the first predetermined direction may be rotating the scroll wheel toward or away from the user.

Therefore, as the above mentioned display control method, only one hand is needed in an operation to move the contents of the document up or down or left or right, as desired.

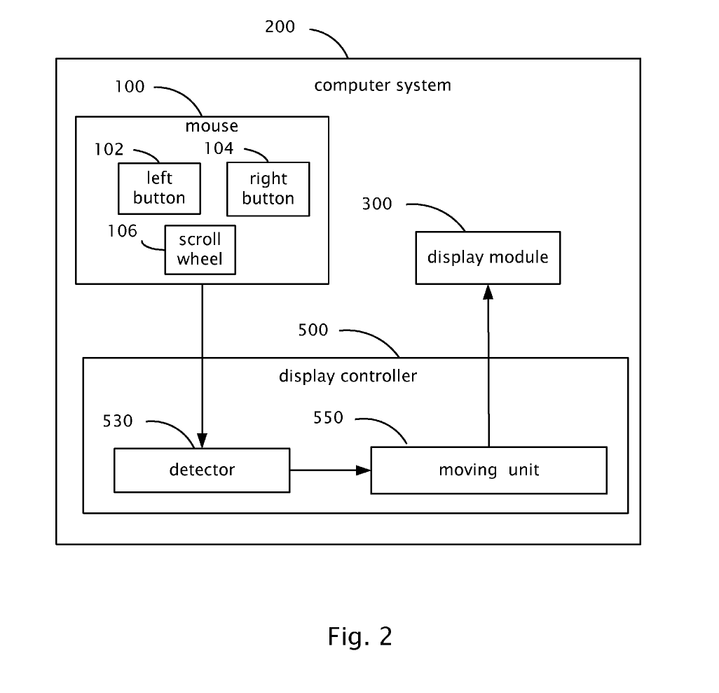

Referring to FIG. 2, a computer system 200 is illustrated in accordance with a first exemplary embodiment. The computer system 200 includes a display controller 500, a mouse 100, and a display module 300. The display controller 500 is electrically connected to the mouse 100 and the display module 300.

The mouse 100 includes a scroll wheel 106, a left button 102, and a right button 104. Each of the scroll wheel 106, the left button 102, and the right button 104 generates corresponding input signals corresponding to the mouse inputs. In the exemplary embodiment, an example input signal may include a scroll signal generated when the scroll wheel 106 is scrolled and a press signal generated when the left button 102 is pressed. Another example input signal may include the scroll signal without the press signal. In other embodiments, the press signal may be generated when the right button 104 is pressed.

The display module 300 is configured for displaying contents of a document displayed in a display window (not shown). The term “document” is used broadly herein to refer to data files of all types including, but not limited to, Web pages from the Internet, image, spreadsheets, and calendars.

The display controller 500 is configured for receiving the input signals, and moving the contents of the document on the display module 300 in response to the input signals.

More specifically, the display controller 500 includes a detector 530 and a moving unit 550.

The detector 530 is used for detecting whether a received input signal generated by the mouse 100 includes the scroll signal and the press signal. More specifically, when the received input signal includes the scroll signal and the press signal, the detector 530 generates a first control signal for instructing the moving unit 550 to move the contents of the document horizontally across the display module 300. When the received input signal includes the scroll signal and no press signal, the detector 530 generates a second control signal for instructing the moving unit 550 to move the contents of the document vertically across the display module 300.

For example, in the exemplary embodiment, the first control signal instructs the moving unit 550 to move the contents of the document left so as to display a right portion of the contents of the document when the scroll signal is generated by rotating the scroll wheel in a predetermined first direction. Likewise, the first control signal instructs the moving unit 550 to move the contents of the document right so as to show a left portion of the contents of the document when the scroll signal is generated by rotating the scroll wheel in a predetermined second direction opposite to the predetermined first direction. The second control signal instructs the moving unit 550 to move the contents of the document in the up direction so as to display any unseen bottom portion of the contents of the document when the scroll signal is generated by rotating the scroll wheel in the predetermined first direction. The second control signal instructs the moving unit 550 to move the contents of document downwards so as to show an upper portion of the contents of document when the scroll signal is generated by rotating the scroll wheel in the predetermined second direction.

In other exemplary embodiments, the second control signal instructs the moving unit 550 to move the contents of the document up when the scroll signal is generated by rotating the scroll wheel in the predetermined second direction, and moves the contents of the document down when the scroll signal is generated by rotating the scroll wheel in the predetermined first direction.

The moving unit 550 is configured for receiving the first control signal and the second control signal, and moving the contents of document displayed in the display module 300 left or right according to the first control signal, or moving the document up or down relative to the display window according to the second control signal.

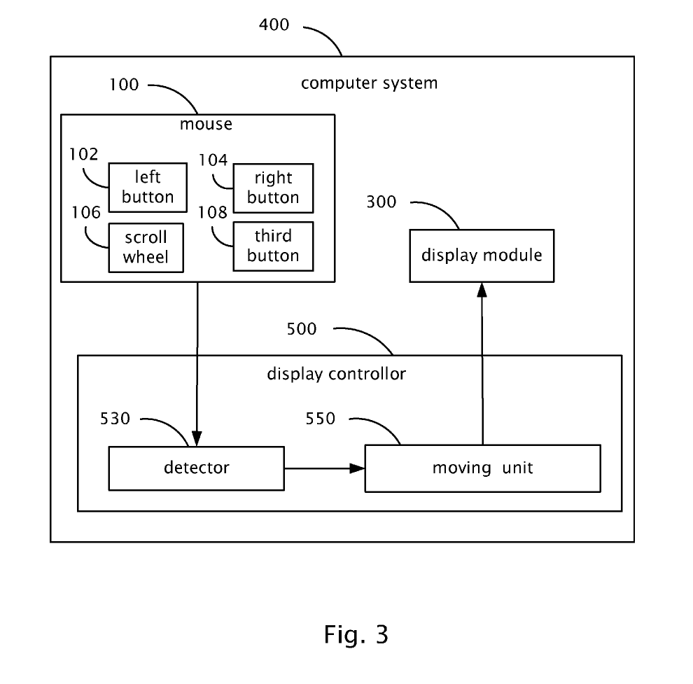

Referring to FIG. 3, a computer system 400 is illustrated in accordance with a second exemplary embodiment. A difference between the computer system 200 and the computer system 400 is that the mouse 100 of the computer system 400 further includes a third button 108, and the third button 108 rather than the left button 102 or the right button 104 is operable to generate the press signal.

Therefore, users can use one hand to move the displayed contents of the document left or right by operating the scroll wheel 106 and the predetermined button of the mouse 100 at the same time, which is very convenient for the user.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display control method comprising:
generating an input signal according to a mouse input operation;
detecting whether the input signal comprises a scroll signal generated when a scroll wheel of a mouse is scrolled, and a press signal generated when a predetermined button of the mouse is pressed; and
moving contents of a document being displayed left or right when a detected result is that the input signal comprises the scroll signal and the press signal.

2. The display control method of claim 1, wherein when the scroll signal is generated by the scroll wheel scrolled in a predetermined first direction, the contents of the document are moved left; and when the scroll signal is generated by the scroll wheel scrolled in a predetermined second direction opposite to the predetermined first direction, the contents of the document are moved right.

3. The display control method of claim 1, further comprising:
moving the contents of the document up or down when another detected result is that the input signal comprises the scroll signal and no press signal.

4. The display control method of claim 3, wherein when the scroll signal is generated the scroll wheel scrolled in a predetermined first direction, the contents of the document are moved up, and when the scroll signal is generated by the scroll wheel scrolled in a predetermined second direction opposite to the predetermined first direction, the contents of the document are moved down.

5. The display control method of claim 1, wherein the predetermined button is one of a left button, a right button and a third button of the mouse.

6. A display controller for controlling a document in a display window, comprising:
a detector for generating a first control signal when receiving an input signal comprising a scroll signal generated by a scroll wheel of the mouse and a press signal generated by a predetermined button of the mouse; and
a moving unit for moving the contents of the document left or right so as to adjust displayed content in a display window in response to the first control signal.

7. The display controller of claim 6, wherein the moving unit moves the contents of the document left when the scroll signal is generated by the scroll wheel in a first direction, or moves the contents of the document right when the scroll signal is generated by the scroll wheel in a predetermined second direction opposite to the predetermined first direction.

8. The display controller of claim 6, wherein the detector further generates a second signal when receiving an input signal comprising the scroll signal and no press signal, the moving unit further moves the contents of the document up or down so as to adjust displayed contents in a display window in response to the second control signal.

9. The display controller of claim 8, wherein the moving unit moves the contents of the document up when the scroll signal is generated by the scroll wheel in a first direction, and moves the contents of the document downward when the scroll signal is generated by the scroll wheel in a predetermined second direction opposite to the predetermined first direction.

10. The display controller of claim 6, wherein the predetermined button is one of a left button, a right button and a third button of the mouse.

11. A computer system comprising:
a mouse for generating an input signal according to a user's operation, the mouse comprises a scroll wheel and a button;
a display module for displaying contents of a document;
a display controller electronically connected to the mouse and the module, the display controller for generating a first control signal when the scroll wheel is scrolled and the button is pressed at the same time; and moving the contents of the document horizontally across the display module in response to the first control signal.

12. The computer system of claim 11, wherein the moving unit moves the contents of document left when the scroll wheel is scrolled in a predetermined first direction, or moves the contents of document right when the scroll wheel is scrolled in a predetermined second direction opposite to the predetermined first direction.

13. The computer system of claim 11, wherein the display controller further generates a second signal when the scroll wheel is scrolled and the button is not pressed, and moves the contents of document vertically across the display module in response to the second control signal.

14. The computer system of claim 13, wherein the moving unit moves the contents of the document up when the scroll wheel is scrolled in a predetermined first direction, and moves the contents of document down when the scroll wheel is scrolled in a predetermined second direction opposite to the predetermined first direction.

15. The computer system of claim 11, wherein the button is one of a left button, a right button and a third button of the mouse.
